(19) United States
(12) Patent Application Publication
(10) Pub. No.: US 2020/0063629 A1
(43) Pub. Date: Feb. 27, 2020

(54) SYSTEM AND METHOD FOR EXHAUST GAS AFTER TREATMENT

(71) Applicants: Hyundai Motor Company, Seoul (KR); Kia Motors Corporation, Seoul (KR)

(72) Inventors: Ingmar Langer, Darmstadt (DE); Stefan Lang, Graevenwiesbach (DE); Roman Pelzetter, Reichelsheim (DE); Michael Schreiber, Frankfurt am Main (DE); Peter Gozner, Mannheim (DE); Ulrich Karrer, Russelsheim (DE); Andreas Kapp, Eschborn (DE)

(73) Assignees: Hyundai Motor Company, Seoul (KR); Kia Motors Corporation, Seoul (KR)

(21) Appl. No.: 16/152,740

(22) Filed: Oct. 5, 2018

(30) Foreign Application Priority Data
Aug. 23, 2018 (DE) 10 2018 214 268.8

(51) Int. Cl. F01N 3/28; F01N 11/00; F01N 3/20; B01D 53/94

(52) U.S. Cl. CPC F01N 3/2892; F01N 3/2839; F01N 11/002; F01N 3/208; F01N 2900/1602; B01D 53/9431; B01D 53/9418; F01N 2550/02; B01D 53/9495

(57) ABSTRACT

A system for exhaust gas after-treatment may include a catalytic converter with an entrance surface and an exit surface, a substrate disposed between the entrance surface and the exit surface, wherein the substrate is configured to conduct the exhaust gas after-treatment at a predetermined temperature and at least one cover element disposed on the entrance surface, and wherein the at least one cover element is configured to at least partially close or at least partially open the entrance surface in relation to the predetermined temperature of the substrate.

### CROSS-REFERENCE TO RELATED APPLICATION

The present application claims priority to DE 102018214268.8, filed on Aug. 23, 2018, the entire contents of which is incorporated herein for all purposes by this reference.

### BACKGROUND OF THE INVENTION

### Field of the Invention

The present invention relates to a system for exhaust gas after-treatment, in particular, during operation of a combustion engine of a vehicle, and further relates to a method for exhaust gas after-treatment.

### Description of Related Art

A catalytic converter is an exhaust emission control device that converts toxic gases and pollutants in exhaust gas from an internal combustion engine into less-toxic pollutants by catalyzing a redox reaction (an oxidation and a reduction reaction). Catalytic converters are in particular used with internal combustion engines fueled by either petrol (gasoline) or diesel—including lean-burn engines as well as kerosene heaters and stoves. Furthermore, use of catalytic converters are known in gas engines, for example, Liquid Natural Gas engines or Compressed Natural Gas engines.

Catalytic converters require a certain temperature to work properly. Typically, catalytic converters use large surface to efficiently conduct the chemical reactions, such as the redox reaction. Typically, catalytic converters need, in particular, during cold-start, long time for heating up its substrate, also referred to as catalyst support. Therefore, in particular during the heating up phase the catalytic converters have difficulties to meet federal emission requirements, for example. Furthermore, emission regulations including integration of cold-start phase into a test cycle, become more strictly.

Efforts are being made to improve the heating up phase to efficiently operate the catalytic converter, in particular at cold-start. Therefore, there is a high interest to provide a system that provides efficient exhaust gas after-treatment.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a system for exhaust gas after-treatment and a method for exhaust gas after-treatment.

Various exemplary embodiments of the present invention are subject of the corresponding dependent claims and of the following description, referring to the drawings.

In various aspects of the present invention, by reducing the entrance surface of the catalytic converter the exhaust gas after-treatment, in particular selective catalytic reduction, can be efficiently conducted because the predetermined temperature to conduct corresponding chemical reactions, such as redox reaction, can be earlier realized than without any cover element disposed on the entrance surface. Furthermore, a potential loss due to the reduced entrance surface is comparably low.

In various aspects of the present invention, the substrate may include at least one first channel and at least one second channel, wherein the at least one first channel is configured to be heated up to the predetermined temperature via the exhaust gas and wherein the at least one second channel is configured to be heated up by thermal conduction between the at least one first channel and the at least one second channel. The at least one first channel may be therefore free of the at least one cover element at the entrance surface. The at least second channel may therefore be covered by the at least one cover element or at least partially closed by the same. In other words, the entrance surface, where the exhaust gas may be entered may be defined by the at least one cover element that at least partially covers the at least second channel. Therefore, the at least one first channel may be efficiently heated up due to the reduced entrance surface whereby the exhaust gas after-treatment may be efficiently conducted. That is, the temperature delivered form the exhaust gas may be also used to heat up neighboring or adjacent channels—here the at least one second channel—of the catalytic converter.

In various aspects of the present invention, the at least one cover element is configured to at least partially close or open the entrance surface depending on a driving condition. The system may consider different driving conditions. For example, when high power is requested from the engine the closed or covered portion of the entrance surface may be opened to ensure that a back pressure is not going above a set limit. The set limit may be engine-specific and needs to be determined for each engine individually. Therefore, the described system can interchange data with the engine, wherein in connection with the engine-specific data the described system may be started, respectively.

In various aspects of the present invention, the exhaust gas after-treatment is based on a selective catalytic reduction (SCR). With the described system, in particular, the selective catalytic reduction during cold start may be efficiently improved. For example, the described system may be efficiently driven in urban traffic.

In various aspects of the present invention, the predetermined temperature is detected on the exit surface of the catalytic converter. For example, the predetermined temperature is detected via temperature sensors disposed on the exit surface. For example, a homogeneous temperature distribution on the entire exit surface may be measured.

It may be further conceivable that based on the temperature sensors, temperature models for the system may be developed and/or simulated, wherein the temperature sensors may be used for testing phases. Corresponding results of the testing phases may be used for temperature models depending on different driving conditions, wherein the temperature models may be a function of various input parameters, such as time, exhaust gas temperature and mass flow, environmental temperature, engine off time, positions of the at least one cover element and/or thermal conduction ratio (based on thermal inertia of the system) and engine operation status (e.g., regeneration or overrun). That is, when the temperature models show that the predetermined temperature is reached the at least one cover element of the system may open the entire entrance surface. In other words, the system may also be conducted without temperature sensors.

In various aspects of the present invention, the predetermined temperature is a light-off temperature. The light-off temperature is a temperature at which catalytic reaction are initiated within the catalytic converter and the substrate, respectively. The substrate or catalyst support is typically a core of the catalytic converter and the substrate may be a ceramic monolith that has a honeycomb structure. The substrate is structured to produce a large surface area.

In various aspects of the present invention, the at least one cover element may include at least one flap, wherein the at least one flap is configured to be hinged on at least one edge of the entrance surface. The entrance surface of the catalytic converter can have different geometric forms such as rectangular, circular, hexagonal or square. The at least one edge portion of the entrance surface may limit or define the geometric form of the entrance surface and the catalytic converter, respectively.

In various aspects of the present invention, the at least one cover element may include at least one flap wherein the at least one flap is configured to be slid around the at least one edge portion of the entrance surface. The opening and closing of the entrance surface may be conducted gradually. Also the opening and closing via stepless sliding of the flap around the at least one edge portion may be conceivable. Therefore, the system may be provided in space saving manner.

In various aspects of the present invention, the at least one cover element may include a circular shutter and the circular shutter is configured to stepless change its internal diameter or cross-section. The circular shutter may limit an external diameter or external dimensions of the entrance surface, wherein the internal diameter or cross-section of the circular shutter may define or limit the corresponding opening of the entrance surface. In other words, the circular shutter may function like an aperture, wherein the aperture may narrow or widen the opening of the entrance surface. Therefore, the heat up of the substrate may be efficiently conducted.

In various aspects of the present invention, the at least one cover element may include a flow dividing flap, wherein the flow dividing flap is configured to stepless or gradually close or open a predetermined area of the entrance surface. For example, the flow dividing flap may be disposed on an internal surface of a pipe such that the flow dividing flap may be pivoted in contact with the entrance surface. The pipe may be an exhaust pipe, for example.

The features included for the system are also included for the method and vice versa.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A illustrates a system for exhaust gas after-treatment according to an exemplary embodiment of the present invention;

FIG. 1B illustrates a conventional catalytic converter for exhaust gas after-treatment;

FIG. 2A and FIG. 2B show two graphs to illustrate a comparison of a functionality of a conventional catalytic converter and the system according to an exemplary embodiment of the present invention;

FIG. 3A and FIG. 3B show two graphs to illustrate a comparison of a functionality of a conventional catalytic converter and the system according to various exemplary embodiments of the present invention;

FIG. 4A and FIG. 4B show two graphs to illustrate a comparison of a functionality of a conventional catalytic converter and the system according to various exemplary embodiments of the present invention;

FIG. 5A illustrates a flow diagram in connection with a method for exhaust gas after-treatment according to an exemplary embodiment of the present invention;

FIG. 5B illustrates a flow diagram in connection with a method for exhaust gas after-treatment according to various exemplary embodiments of the present invention;

FIG. 6A and FIG. 6B illustrate a system for exhaust gas after-treatment according to various exemplary embodiments of the present invention;

FIG. 7A and FIG. 7B illustrate a system for exhaust gas after-treatment according to various exemplary embodiments of the present invention;

FIG. 8A and FIG. 8B illustrate a system for exhaust gas after-treatment according to various exemplary embodiments of the present invention;

FIG. 9A and FIG. 9B illustrate a system for exhaust gas after-treatment according to various exemplary embodiments of the present invention;

FIG. 10 shows a graph to illustrate the system for exhaust gas after-treatment according to FIG. 9A and FIG. 9B.

FIG. 11 illustrates a further conventional catalytic converter for exhaust gas after-treatment.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

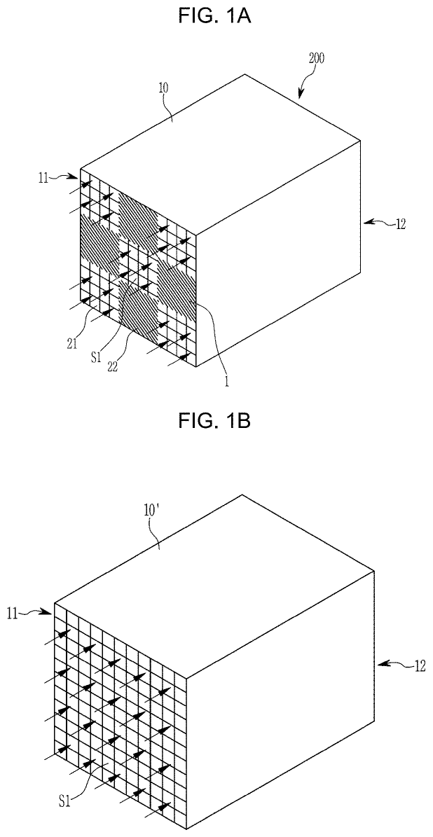

FIG. 1A illustrates a system for exhaust gas after-treatment according to an exemplary embodiment of the present invention.

Reference number 200 relates to a system for exhaust gas after-treatment.

The system 200 for exhaust gas after-treatment includes a catalytic converter 10 with an entrance surface 11 and an exit surface 12, a substrate S1 disposed between the entrance surface 11 and the exit surface 12, wherein the substrate S1 is configured to conduct the exhaust gas after-treatment at a predetermined temperature T1 and at least one cover element 1 disposed on the entrance surface 11, and wherein the at least one cover element 1 is configured to at least partially close or at least partially open the entrance surface 11 in relation to the predetermined temperature T1 of the substrate S1.

The substrate of FIG. 1A includes at least one first channel 21 and at least one second channel 22, wherein the at least one first channel 21 is configured to be heated up to the predetermined temperature T1 via the exhaust gas and wherein the at least one second channel 22 is configured to be heated up by thermal conduction between the at least one first channel 21 and the at least one second channel 22. The at least one first channel 21 is therefore free of the at least one cover element 1 at the entrance surface 11. The at least second channel 22 may therefore be covered by the at least one cover element 1 or at least partially closed by the same. In other words, the entrance surface 11, where the exhaust gas may be entered may be defined by the at least one cover element 1 that at least partially covers the at least second channel 22.

FIG. 1B illustrates a conventional catalytic converter for exhaust gas after-treatment.

The conventional catalytic converter 10′ of FIG. 1B includes the entrance surface 11 and the exit surface 12, wherein the substrate S1 is disposed between the entrance surface 11 and the exit surface 12. In other words, the conventional catalytic converter 10′ is free of the at least one cover element 1.

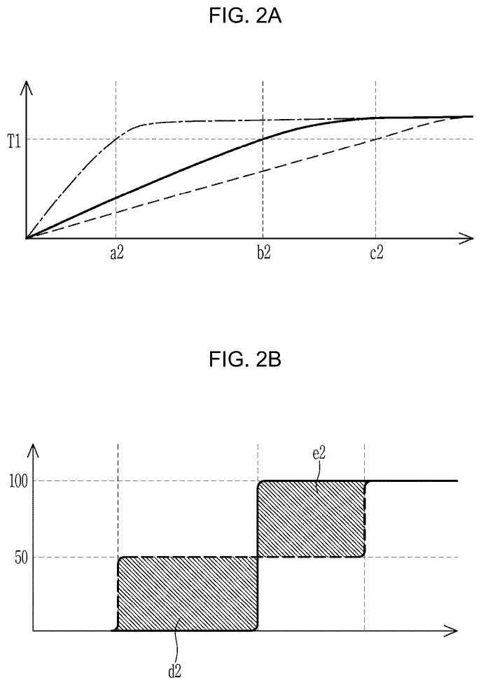

FIG. 2A and FIG. 2B show two graphs to illustrate a comparison of a functionality of the conventional catalytic converter and the system according to an exemplary embodiment of the present invention.

In FIG. 2A a temperature in degree Celsius is plotted on the y-axis, wherein on the x-axis a time in seconds is plotted.

In FIG. 2B an effective conversion area of the entrance surface 11 in percent is plotted, wherein on the x-axis the time in seconds is plotted.

The time plotted on the x-axis applies to the graph of FIG. 2A and FIG. 2B, respectively.

At point a2 the first channels 21 of the substrate 21 reach the predetermined temperature T1 (dotted line). The predetermined temperature T1 may be a light-off temperature T1. That is that in and/or on the first channels 21 a conversion can start efficiently, wherein an opening of the at least one cover element due to thermal conduction starts at point c2 (dashed line). A. At point c2 all of the at least one cover element 1 are configured to be opened since the entire substrate S1 may have reached the light-off temperature.

In comparison the conventional catalytic converter 10′ starts the conversion at point b2 (solid line). As shown in FIG. 2A the conversion starts at an earlier point when reducing the entrance surface 11 by the at least one cover element 1. For example, 50% of the entrance surface 11 may be covered by the at least one cover element 1.

In FIG. 2B reference number d2 refers to a gained conversion due to the earlier conversion at point a2 provided by the described system 20, wherein reference number e2 refers to a lost conversion due to the reduced entrance surface 11 and opening of the at least one cover element 1 at point c2.

As can be seen by at least partially covering the entrance surface 11 with the at least one cover element 1 the conversion starts earlier due to fast heat-up of the non-covered areas of the entrance surface 11—here the first channels 21 (see dotted line and solid line). The lost conversion (at the time when the conventional catalytic converter 10′ starts its conversion using the entire entrance surface 11) may be compensated by the fast heat-up of the first channels 21 and the reduced entrance surface 11 via the at least one cover element 1, respectively (see corresponding hatched areas of FIG. 2B in connection with reference signs d2 and e2).

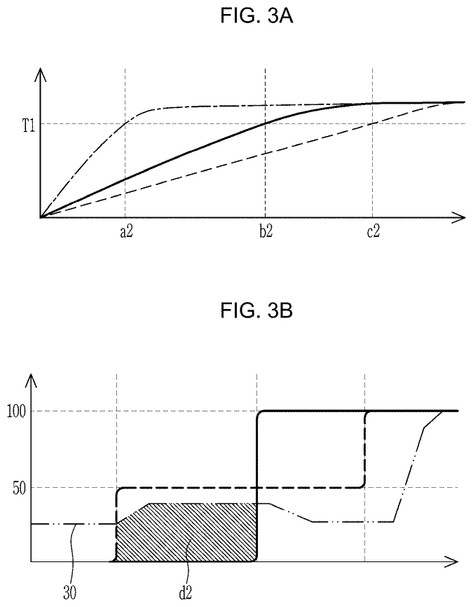

FIG. 3A and FIG. 3B show two graphs to illustrate a comparison of a functionality of a conventional catalytic converter and the system according to various exemplary embodiments of the present invention.

FIG. 3A and FIG. 3B are based on the FIG. 2A and FIG. 2B with the difference that in FIG. 3B a dashed-dotted line 30 is plotted which illustrates the conversion in case of low requested conversion, for example in urban traffic or internal-city driving condition of an engine.

The conversion d2 can already start at point a2, wherein the lost conversion e2 as shown in FIG. 2B does not occur since the effective conversion area of the entrance surface 11 is sufficient. Consequently, the first channels 21 may be efficiently heated-up and the provided entrance surface 11 provided by the described system 200 may be sufficient to provide full conversion in particular in urban traffic. In other words, an opening of the at least on cover element 1 may not occur and an engine performance does not require the entire entrance surface 11 of the substrate S1.

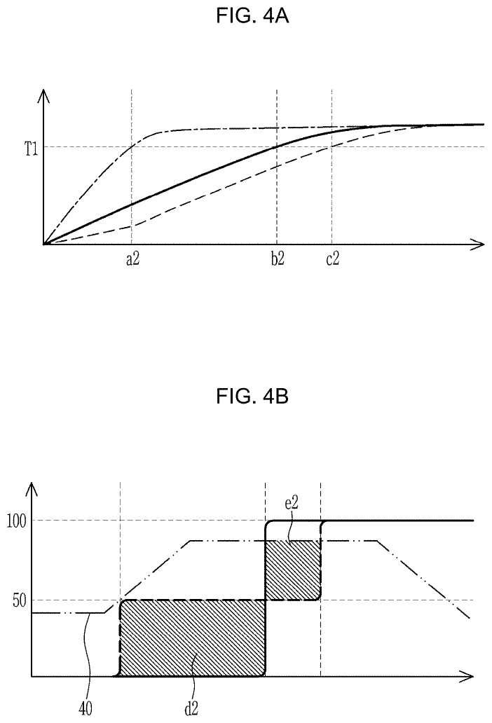

FIG. 4A and FIG. 4B show two graphs to illustrate a comparison of a functionality of a conventional catalytic converter and the system according to various exemplary embodiments of the present invention.

FIG. 4A and FIG. 4B are based on the FIG. 2A and FIG. 2B with the difference that in FIG. 4B a dashed-dotted line 40 is plotted which illustrates the conversion in case of high requested conversion, for example during acceleration or entering a freeway directly after cold start.

The hatched area d2 in FIG. 4B illustrates that even during acceleration or entering a freeway directly after cold start the gained conversion is high due to the fast heat-up of the first channels 21 of the entrance surface 11. In other words, the lost conversion e2 is comparably low with respect to the gained early starting conversion based on the reduced entrance surface 11. The at least one cover element 1 is configured to at least partially close or open the entrance surface 11 depending on a driving condition. Therefore, the system 200 may consider different driving conditions. For example, when high power is requested from the engine the closed or covered portion of the entrance surface—second channels 22—may be opened to ensure a back pressure is not going above a set limit. The set limit may be engine-specific and needs to be calculated for each engine individually. Therefore, the described system 200 can interchange data with the engine, wherein in connection with the engine-specific data the described system 200 can be started, respectively.

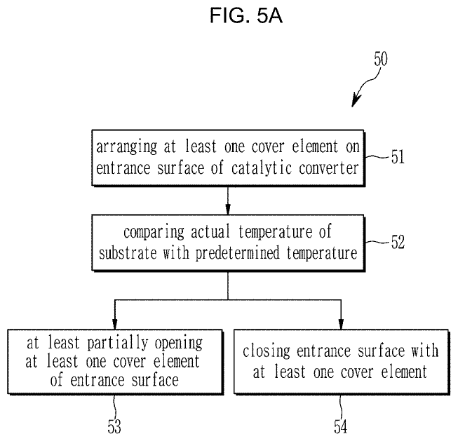

FIG. 5A illustrates a flow diagram in connection with a method for exhaust gas after-treatment according to an exemplary embodiment of the present invention.

The reference number 50 of FIG. 5A refers to a method for exhaust gas after-treatment.

The method 50 for exhaust gas after-treatment includes the steps 51, 52 and 53 or 54.

In the step 51 the at least one cover element 1 is disposed on the entrance surface 11 of the catalytic converter 10, wherein the catalytic converter 10 includes the substrate S1.

In step 52 an actual temperature of the substrate is compared with the predetermined temperature T1 for the exhaust gas after-treatment.

In step 53 the at least one cover element 1 of the entrance surface 11 is at least partially opened in case the actual temperature is higher than or equal to the predetermined temperature T1, or wherein in step 54 the entrance surface 11 is closed or covered with the at least one cover element 1 in case the actual temperature is lower than the predetermined temperature T1.

FIG. 5B illustrates a flow diagram in connection with a method for exhaust gas after-treatment according to various exemplary embodiments of the present invention.

The flow diagram of FIG. 5B is based on the flow diagram of FIG. 5A with the difference that the at least one cover element 1 is at least partially opened or at least partially closed depending on a driving condition after the step 52 comparing the actual temperature of the substrate S1 with the predetermined temperature T1 for the exhaust gas after-treatment (see reference number 52′).

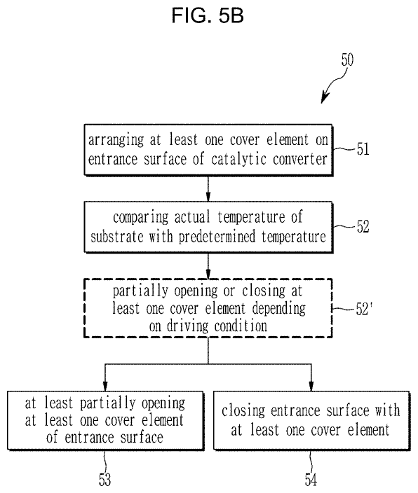

FIG. 6A and FIG. 6B illustrate a system for exhaust gas after-treatment according to various exemplary embodiments of the present invention.

The at least one cover element 1 of the system 200 of FIG. 6A and FIG. 6B includes at least one flap, wherein the at least one flap is configured to be hinged on at least one edge portion E1 of the entrance surface 11 (see FIG. 6B).

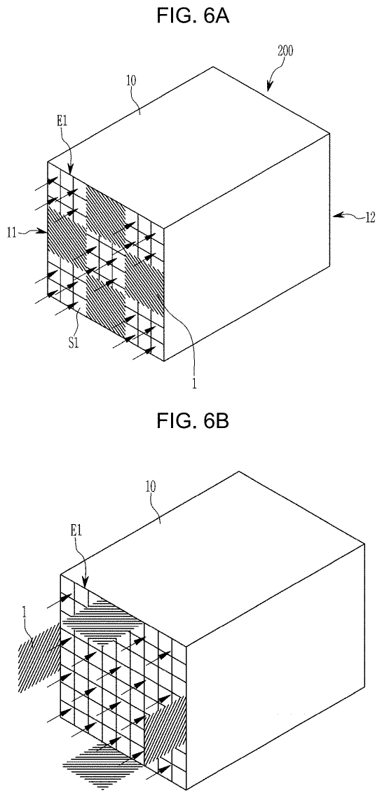

FIG. 7A and FIG. 7B illustrate a system for exhaust gas after-treatment according to various exemplary embodiments of the present invention.

The at least one cover element 1 of the system 200 of FIG. 7A and FIG. 7B includes at least one flap, wherein the at least one flap is configured to be slid around the at least one edge portion E1 of the entrance surface 11 (see FIG. 7B).

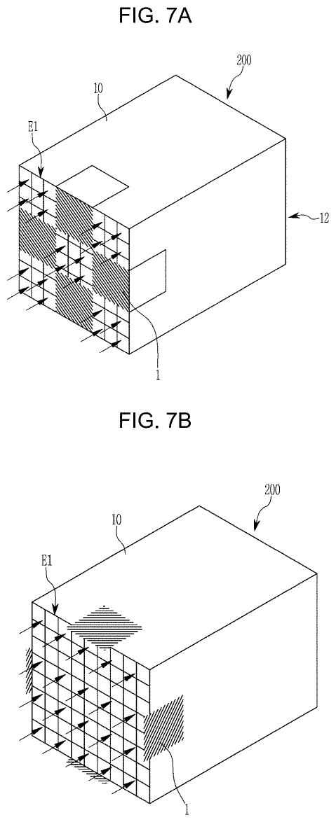

FIG. 8A and FIG. 8B illustrate a system for exhaust gas after-treatment according to various exemplary embodiments of the present invention.

The at least one cover element 1 of the system 200 may include a circular shutter and the circular shutter is configured to stepless change its internal diameter D1 or cross-section Cl. In other words, the circular shutter may function like an aperture, wherein the aperture may narrow or widen the opening of the entrance surface.

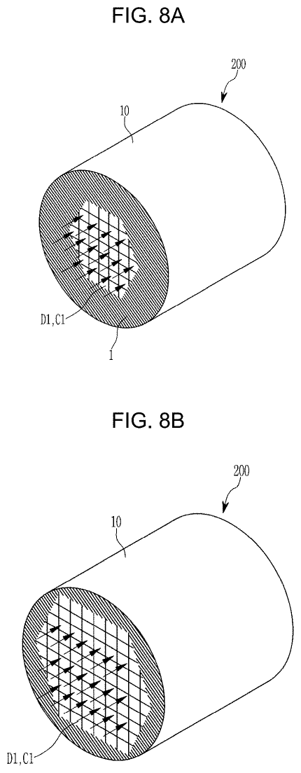

FIG. 9A and FIG. 9B illustrate a system for exhaust gas after-treatment according to various exemplary embodiments of the present invention.

The at least one cover element 1 of the system 200 of FIG. 9A includes a flow dividing flap, wherein the flow dividing flap 35 is configured to stepless or gradually close or open a predetermined area A1 of the entrance surface 11. For example, the flow dividing flap may be disposed on an internal surface of a pipe L1 such that the flow dividing flap may be pivoted in contact with the entrance surface. The pipe L1 may be an exhaust pipe, for example.

The system 200 may further include at least one sensor 60. The at least one sensor 60 may be configured to measure the temperature, in particular the light-off temperature, and/or a pressure, respectively. The sensor 60 may be disposed on the exit surface 12 of the catalytic converter 10. The sensor 60 may be disposed on the exit surface 12 in connection with a first, second and/or third position P1, P2, P3 of the at least one cover element 1—here the flow dividing flap as shown in FIG. 9B. The flow dividing flap can define a closed or opened section of the predetermined area A1 of the entrance surface 11. That is, that the flow dividing flap may determine the cross-section Cl of the second channel 22.

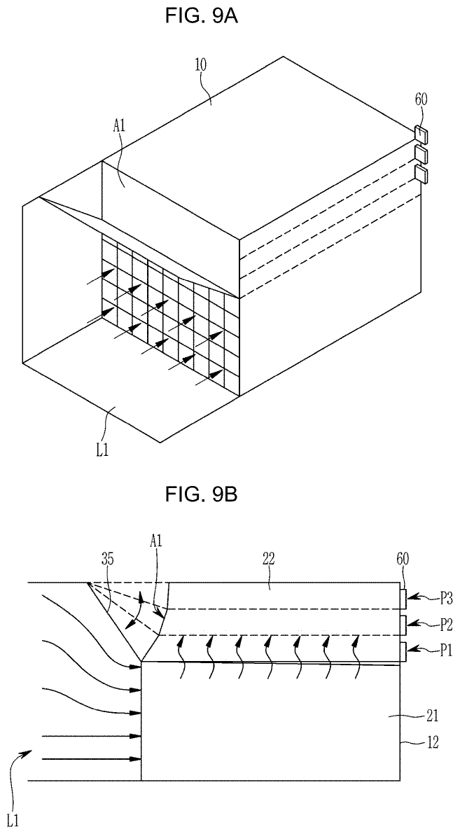

FIG. 10 shows a graph to illustrate the system for exhaust gas after-treatment according to FIG. 9A and FIG. 9B.

The graph of FIG. 10 is based on the graph of FIG. 2A with the difference that on the right hand side of the graph a position of the flow dividing flap is plotted, wherein in position of zero, the flow dividing flap covers the entire predetermined area A1 and in position of one the predetermined area A1 is not covered with the flow dividing flap. FIG. 10 illustrates that in connection with the positions P1, P2, P3 of the flow dividing flap the time at which the second channels 22 reach the light-off temperature differs dependent on the first, second, and third position P1, P2, P3 of the flow dividing flap. The reference signs a3, c3, b3 relates to the light-off temperature of the at least one second channel 22. Dependence on the light-off temperature of the second channel 22 the flow dividing flap may continuously and slowly change its position from zero to one.

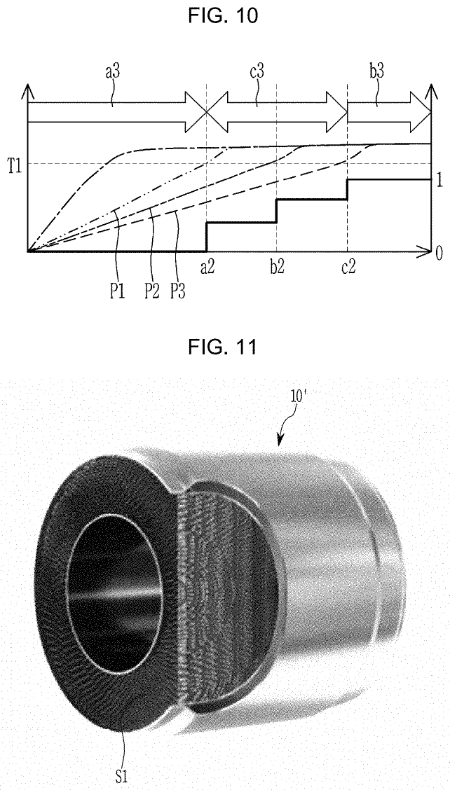

FIG. 11 illustrates a further conventional catalytic converter for exhaust gas after-treatment.

FIG. 11 illustrates the conventional catalytic converter 10′ with the substrate S1 having a round shape.

It is clear from the context of the present invention that the described system may be also adapted to any kind of vehicle which produces exhaust gas.

Although the here afore-mentioned system has been described in connection with vehicles, respectively, for a person skilled in the art it is clearly and unambiguously understood that the described system may be applied to various exhaust gas after-treatment purposes.

Generally, the present invention is directed to cover any adaptations or variations of the specific embodiments discussed herein.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A system for exhaust gas after-treatment, the system comprising:
a catalytic converter formed of an entrance surface and an exit surface;
a substrate disposed between the entrance surface and the exit surface, wherein the substrate conducts the exhaust gas after-treatment at a predetermined temperature; and
at least one cover element disposed on the entrance surface,
wherein the at least one cover element partially close or partially open the entrance surface in relation to the predetermined temperature of the substrate.

2. The system according to claim 1,
wherein the substrate includes at least one first channel and at least one second channel,
wherein the at least one first channel is heated up to the predetermined temperature via exhaust gas, and
wherein the at least one second channel is heated up by thermal conduction between the at least one first channel and the at least one second channel.

3. The system according to claim 1, wherein the at least one cover element partially close or open the entrance surface depending on a driving condition of an engine.

4. The system according to claim 1, wherein the exhaust gas after-treatment is based on a selective catalytic reduction.

5. The system according to claim 1, wherein the predetermined temperature is detected on the exit surface of the catalytic converter.

6. The system according to claim 1, wherein the predetermined temperature is a light-off temperature.

7. The system according to claim 1, wherein the at least one cover element includes at least one flap hinged on at least one edge portion of the entrance surface.

8. The system according to claim 1, wherein the at least one cover element includes at least one flap configured to be slid around at least one edge portion of the entrance surface.

9. The system according to claim 1, wherein the at least one cover element includes a circular shutter and the circular shutter is configured to selectively change an internal diameter or cross-section of the circular shutter.

10. The system according to claim 1, wherein the at least one cover element includes a flow dividing flap pivotally mounted to the catalytic converter, and wherein the flow dividing flap is configured to close or open a predetermined area of the entrance surface.

11. A method for exhaust gas after-treatment, the method comprising:
arranging at least one cover element on an entrance surface of a catalytic converter, wherein the catalytic converter includes a substrate;
comparing a detected temperature of the substrate with a predetermined temperature for the exhaust gas after-treatment; and
partially opening the at least one cover element of the entrance surface when the detected temperature is higher than or equal to the predetermined temperature or closing the entrance surface with the at least one cover element when the detected temperature is lower than the predetermined temperature.

12. The method according to claim 11, wherein the at least one cover element is partially opened or partially closed depending on a driving condition of an engine after comparing the detected temperature of the substrate with the predetermined temperature for the exhaust gas after-treatment.

13. The method according to claim 11, wherein the at least one cover element includes at least one flap hinged on at least one edge portion of the entrance surface.

14. The method according to claim 11, wherein the at least one cover element includes at least one flap configured to be slid around at least one edge portion of the entrance surface.

15. The method according to claim 11, wherein the at least one cover element includes a circular shutter and the circular shutter is configured to selectively change an internal diameter or cross-section of the circular shutter.

16. The method according to claim 11, wherein the at least one cover element includes a flow dividing flap pivotally mounted to the catalytic converter, and wherein the flow dividing flap is configured to close or open a predetermined area of the entrance surface.
